(19) United States
(12) Patent Application Publication
(10) Pub. No.: US 2023/0024297 A1
(43) Pub. Date: Jan. 26, 2023

(54) Wiping Products Made from Foam Formed Webs

(71) Applicant: Kimberly-Clark Worldwide, Inc., Neenah, WI (US)

(72) Inventors: Michael Payne, Acworth, GA (US); Marvin E. Swails, Alpharetta, GA (US); Cristine E. Schulz, Roswell, GA (US); David A. Lilley, Salem, SC (US); Joseph K. Baker, Cumming, GA (US)

(21) Appl. No.: 17/779,646

(22) PCT Filed: Dec. 31, 2019
(86) PCT No.: PCT/US2019/069058

§ 371 Date: May 25, 2022

(51) Int. Cl. D04H 1/4258; D04H 1/435; D04H 1/492; D04H 1/4291; D04H 1/4391; D04H 1/425; C11D 17/04

(52) U.S. Cl. CPC D04H 1/4258; D04H 1/435; D04H 1/492; D04H 1/4291; D04H 1/4391; D04H 1/425; C11D 17/049; D10B 2401/063; D10B 2201/02; D10B 2505/00; D10B 2201/22

(57) ABSTRACT

A process for foam forming webs is disclosed. The foam formed webs can be used as wiping products, such as industrial wipers, food service wipers, and the like. The web contains a mixture of cellulosic fibers and longer, strength building fibers. The web is foam formed and then subjected to one or more hydroentangling steps. After hydroentangling, the web is dried in a non-compressive manner.

### BACKGROUND

Conventional wiping products have been made from woven and knitted fabrics. Such wipers have been used in all different types of industries, such as for industrial applications, food service applications, health and medical applications, and for general consumer use. Conventional rags and washcloths can be reusable if laundered properly. Disposable wipers, however, continue to gain in popularity and are readily displacing many conventional woven or knitted products. Disposable wipers, for instance, can offer many advantages. For example, disposable wipers are generally more sterile and free of debris and contaminants. Laundered rags and washcloths, for instance, can still contain residual debris from past use and can also pick up debris during the laundering process. In addition, laundering woven or knitted wipers can not only create a great expense, but also requires the use of copious amounts of water and detergents that must be properly disposed of. Further, in many applications, especially in the industrial setting, conventional cloth wipers are disposed of after a single use due to the chemicals and other debris that come into contact with the wiper.

Problems, however, have been experienced in being able to produce a disposable wiper that has the strength and absorbency properties of conventional cloth wipers. For example, although pulp fiber webs are known to be absorbent, webs made from pulp fibers lack strength and abrasion resistance, especially when used in a wet state.

In view of the above drawbacks, pulp fibers have been combined with other webs in order to increase strength, particularly wet strength. For example, in the past, spunbond webs made from continuous filaments have been hydroentangled with pulp fibers in order to produce a resilient wiping product. Although such wipers have made great advances in the art, the spunbond portion of the wiper tends to inhibit liquid absorbency and wipe-dry properties.

Attempts have also been made to combine pulp fibers with longer, staple fibers. Such fiber mixtures, however, are very difficult to handle in a conventional wetlaid forming process because only relatively short fibers are able to be transported in a water medium during formation of the web and the longer fibers have a tendency to clump and floc together when combined with a sufficient amount of water to produce the web. Thus, such products not only lack integrity but have a very non-uniform fiber consistency.

In still another embodiment, precursor webs have been formed via a carding process. The carded web is then entangled with pulp fibers. Producing a carded web is not only a very inefficient manner of producing a web, but the resulting product still tends to lack many desirable properties in comparison to cloth products, such as absorbency, consistency and strength.

In view of the above, a need currently exists for a process for producing disposable wipers. In particular, a need exists for a disposable wiper that has enhanced mechanical properties in conjunction with good absorbency that can effectively replace conventional cloth wipers. A need also exists for a process of combining longer fibers with water absorbent pulp fibers to produce a disposable wiping product that has a fiber matrix with improved absorbency, wipe-dry characteristics, oil and grease wiping characteristics, durability, and the like.

### SUMMARY

In general, the present disclosure is directed to a disposable wiping product and to a process for making the wiping product. The wiping product of the present disclosure is produced through a foam forming process in which shorter and highly liquid absorbent pulp fibers are combined with longer, strength-building fibers. The resulting web is then hydroentangled one or more times to further improve integrity and various other characteristics of the web. The foam forming process, for instance, produces a web with a substantially homogeneous fiber matrix. Hydroentangling the foam formed web increases web integrity and provides structural topography for increased bulk. Hydroentangling can also improve the aesthetic appearance of the wiping product.

For example, in one embodiment, the present disclosure is directed to a wiping product comprising a foam formed web containing a mixture of fibers. The fibers comprise cellulosic fibers blended with strength building fibers. The strength building fibers can have an average length of greater than about 8 mm and less than about 30 mm. The strength building fibers are present in the web in an amount from about 5% to about 50% by weight, such as from about 15% to about 40% by weight. The foam formed web is subjected to at least one hydroentangling step. For example, the foam formed web can include a first surface and a second and opposite surface. The first surface and the second surface can both be subjected to hydroentangling.

The strength building fibers can be made from various different materials, such as a polymer. For example, the strength building fibers can comprise polyester fibers, polyolefin fibers such as polyethylene fibers, regenerated cellulose fibers such as rayon fibers, cotton fibers, or the like. The strength building fibers can be monocomponent fibers or bicomponent fibers. The cellulosic fibers, on the other hand, can comprise pulp fibers. For example, the cellulosic fibers can comprise hardwood fibers, softwood fibers, or mixtures thereof. The pulp fibers can be present in the web in an amount from about 55% to about 80% by weight.

The wiping product of the present disclosure can be a single ply product. As described above, the cellulosic fibers and the strength building fibers can be combined so as to form a substantially homogeneous mixture. For example, the foam formed web can be a non-layered web showing no noticeable separate layers of fibers when the cross-section of the web is examined.

The basis weight of the foam formed web can be from about 15 gsm to about 120 gsm, such as from about 45 gsm to about 80 gsm. The caliper of the foam formed web can be from about 0.4 mm to about 0.9 mm. The web can contain a foaming agent, such as lauryl sulfate. The bulk of the web can be from about 3 cc/g to about 15 cc/g.

Wiping products according to the present disclosure can have excellent physical properties. For instance, the foam formed web can have a wet strength and a dry strength and the wet strength can be within about 20%, such as within about 10%, such as within about 5% of the dry strength. The foam formed web can also have similar strength properties in the length direction or machine direction in comparison to the width direction or cross-machine direction. For example, the ratio between the tensile strength in the machine direction to the tensile strength in the cross-machine direction can be from about 1 to about 4, such as from about 2 to about 3, such as from about 2.3 to about 2.7.

Wiping products made according to the present disclosure can be used in all different types of applications. In one embodiment, the wiping product is an industrial wiper. The wiping product can be in the form of individual sheets that are stacked together. If desired, the wiping product can be presaturated with a cleaning solvent and packaged for use.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a schematic diagram of one embodiment of a process for forming a nonwoven web in accordance with the present disclosure; and

FIG. 2 is a schematic diagram of an enlarged partial view of the schematic diagram illustrated in FIG. 1.

Repeat use of reference characters in the present specification and drawings is intended to represent the same or analogous features or elements of the present invention.

### Definitions

The term “machine direction” as used herein refers to the direction of travel of the forming surface onto which fibers are deposited during formation of a nonwoven web.

The term “cross-machine direction” as used herein refers to the direction which is perpendicular to the machine direction defined above.

The term “pulp” as used herein refers to fibers from natural sources such as woody and non-woody plants. Woody plants include, for example, deciduous and coniferous trees. Non-woody plants include, for example, cotton, flax, esparto grass, milkweed, straw, jute, hemp, and bagasse. Pulp fibers can include hardwood fibers, softwood fibers, and mixtures thereof.

The term “average fiber length” as used herein refers to an average length of fibers, fiber bundles and/or fiber-like materials determined by measurement utilizing microscopic techniques. A sample of at least 20 randomly selected fibers is separated from a liquid suspension of fibers. The fibers are set up on a microscope slide prepared to suspend the fibers in water. A tinting dye is added to the suspended fibers to color cellulose-containing fibers so they may be distinguished or separated from synthetic fibers. The slide is placed under a Fisher Stereomaster II Microscope—S19642/S19643 Series. Measurements of 20 fibers in the sample are made at 20× linear magnification utilizing a 0-20 mils scale and an average length, minimum and maximum length, and a deviation or coefficient of variation are calculated. In some cases, the average fiber length will be calculated as a weighted average length of fibers (e.g., fibers, fiber bundles, fiber-like materials) determined by equipment such as, for example, a Kajaani fiber analyzer Model No. FS-200, available from Kajaani Oy Electronics, Kajaani, Finland. According to a standard test procedure, a sample is treated with a macerating liquid to ensure that no fiber bundles or shives are present. Each sample is disintegrated into hot water and diluted to an approximately 0.001% suspension. Individual test samples are drawn in approximately 50 to 100 ml portions from the dilute suspension when tested using the standard Kajaani fiber analysis test procedure. The weighted average fiber length may be an arithmetic average, a length weighted average or a weight weighted average and may be expressed by the following equation:

$${\sum }_{{x}_{i} = 0}^{k} ( {x}_{i} * {n}_{i} ) / n$$

where
k=maximum fiber length
xᵢ=fiber length
nᵢ=number of fibers having length xi
n=total number of fibers measured.

One characteristic of the average fiber length data measured by the Kajaani fiber analyzer is that it does not discriminate between different types of fibers. Thus, the average length represents an average based on lengths of all different types, if any, of fibers in the sample.

As used herein the term “staple fibers” means discontinuous fibers made from synthetic polymers such as polypropylene, polyester, post consumer recycle (PCR) fibers, polyester, nylon, and the like, and those not hydrophilic may be treated to be hydrophilic. Staple fibers may be cut fibers or the like. Staple fibers can have cross-sections that are round, bicomponent, multicomponent, shaped, hollow, or the like.

As used herein, dry strength or dry tensile strength is measured using a tensile test. The test is performed against samples that have been conditioned at 23° C.±1° C. and 50%±2% relative humidity for a minimum of 4 hours. The samples are cut into three-inch wide strips in the machine direction and cross-machine direction using a precision sample cutter model JDC 15M-10, available from Thwing-Albert Instruments, located in Philadelphia, Pa..

The gauge length of the tensile frame is set to 2 inches. The tensile frame is an Alliance RT/1 frame run with TestWorks 4 software. The tensile frame and the software are available from MTS Systems Corporation, located in Minneapolis, Minn..

A 3-inch sample is placed in the jaws of the tensile frame and subjected to a strain applied at a rate of 25.4 cm per minute until the point of sample failure. The stress on the sample is monitored as a function of the strain. The calculated outputs include the peak load (grams-force/3 inches, measured in grams-force), the peak stretch (%, calculated by dividing the elongation of the sample by the original length of the sample and multiplying by 100%), the percent stretch at 500 grams-force, the tensile energy absorption (TEA) at break (grams-force*cm/cm², calculated by integrating or taking the area under the stress-strain curve up to the point of failure where the load falls to 30% of its peak value), and the slope A (kilograms-force, measured as the slope of the stress-strain curve from 57-150 grams-force).

A product is measured using five replicate samples. The product is tested in the machine direction and the cross-machine direction.

Wet strength or wet tensile strength is measured in the same manner as dry strength except that the samples are wetted prior to testing. Specifically, in order to wet a sample, a 3 inch×5 inch tray is filled with distilled or deionized water at a temperature of 23° C.±2° C. The water is added to the tray to an approximate 1 cm depth.

A 3M “Scotch-Brite” general purpose scrubbing pad is cut to dimensions of 2.5 inches by 4 inches. A piece of masking tape approximately 5 inches long is placed along one of the four inch edges of the pad. The masking tape is used to hold the scrubbing pad.

The scrubbing pad is then placed in the water with the taped end facing up. The pad remains in the water at all times until testing is completed. The sample to be tested is placed on blotter paper that conforms to TAPPI T205. The scrubbing pad is removed from the water bath and tapped lightly three times on a screen associated with the wetting pan. The scrubbing pad is then gently placed on the sample parallel to the width of the sample in the approximate center. The scrubbing pad is held in place for approximately one second. The sample is then immediately put into the tensile tester and tested.

To calculate the wet/dry tensile strength ratio, the wet tensile strength value is divided by the dry tensile strength value.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a wiping product that is formed with a carefully selected blend of fibers and formed in a certain manner that greatly improves the physical properties of the product in conjunction with its ability to clean or wipe up adjacent surfaces. Wiping products according to the present disclosure are formed from a foam formed web that includes an integrated and entangled fiber matrix that improves the wipe-dry properties, oil and grease wiping properties, durability, and the like. Due to the manner in which the web is formed, the wiping product also has increased bulk, increased caliper, and a soft feel. The wiping product can also be made with a distinctive pattern that improves the aesthetic appeal of the product.

The wiping product of the present disclosure is formed from a combination of shorter cellulosic fibers, such as pulp fibers, combined with longer, strength building fibers. The fiber mixture is combined with a foaming agent in an aqueous solution and deposited onto a forming surface. The foam-forming process provides numerous advantages and benefits. For example, the foam-forming process was found to produce a substantially homogeneous fiber web made from a blend of the shorter cellulosic fibers with the longer strength building fibers. In fact, the foam-forming process was found to accommodate extremely long fibers without experiencing clumping and other problems that are typically experienced in a wetlaid process. By forming a substantially homogeneous fiber mixture within the web, the different fibers provide benefits throughout the entire web structure, which provides dramatic improvements over prior hydroentangled webs that were anchored with a spunbond web that remained as a separate layer within the web structure. Foam formed webs according to the present disclosure, on the other hand, can have a non-layered structure.

Once the foam formed web is produced, in accordance with the present disclosure, the web is subjected to at least one hydroentangling process. The high pressure hydroentangling jets maintain the homogeneous and non-layered structure of the web while further entangling the fibers and significantly increasing web integrity and various mechanical properties. In one embodiment, the foam formed web can be subjected to hydroentangling on each surface of the web. During hydroentangling, a pattern can also be created on each surface of the web which can further improve not only the wiping properties but also the aesthetic qualities of the resulting product. After hydroentangling, the foam formed web can be dried using a non-compressive drying process. For example, the web can be dried using a through-air dryer.

There are many advantages and benefits to a foam forming process as described above. During a foam forming process, water is replaced with foam as the carrier for the fibers that form the web. The foam, which represents a large quantity of air, is blended with papermaking fibers. Since less water is used to form the web, less energy is required in order to dry the web. For instance, drying the web in a foam forming process can reduce energy requirements by greater than about 10%, such as greater than about 20% in relation to conventional wet pressing processes.

In forming tissue or paper webs in accordance with the present disclosure, in one embodiment, a foam is first formed by combining water with a foaming agent. The foaming agent, for instance, may comprise any suitable surfactant. In one embodiment, for instance, the foaming agent may comprise sodium lauryl sulfate, which is also known as sodium laureth sulfate or sodium lauryl ether sulfate. Other foaming agents include sodium dodecyl sulfate or ammonium lauryl sulfate. In other embodiments, the foaming agent may comprise any suitable cationic and/or amphoteric surfactant. For instance, other foaming agents include fatty acid amines, amides, amine oxides, fatty acid quaternary compounds, and the like.

The foaming agent is combined with water generally in an amount greater than about 2% by weight, such as in an amount greater than about 5% by weight, such as in an amount greater than about 10% by weight, such as in an amount greater than about 15% by weight. One or more foaming agents are generally present in an amount less than about 50% by weight, such as in an amount less than about 40% by weight, such as in an amount less than about 30% by weight, such as in an amount less than about 20% by weight.

Once the foaming agent and water are combined, the mixture is blended or otherwise subjected to forces capable of forming a foam. A foam generally refers to a porous matrix, which is an aggregate of hollow cells or bubbles which may be interconnected to form channels or capillaries.

The foam density can vary depending upon the particular application and various factors including the fiber furnish used. In one embodiment, for instance, the foam density of the foam can be greater than about 200 g/L, such as greater than about 250 g/L, such as greater than about 300 g/L. The foam density is generally less than about 600 g/L, such as less than about 500 g/L, such as less than about 400 g/L, such as less than about 350 g/L. In one embodiment, for instance, a lower density foam is used having a foam density of generally less than about 350 g/L, such as less than about 340 g/L, such as less than about 330 g/L. The foam will generally have an air content of greater than about 30%, such as greater than about 40%, such as greater than about 50%, such as greater than about 60%. The air content is generally less than about 80% by volume, such as less than about 70% by volume, such as less than about 65% by volume.

Once the foam is formed, the foam is combined with a fiber furnish. In accordance with the present disclosure, the fiber furnish includes a combination of shorter and highly liquid absorbent cellulosic fibers combined with longer, strength building fibers.

Cellulosic fibers that may be incorporated into the web include but not limited to nonwoody fibers, such as cotton, abaca, kenaf, sabai grass, flax, esparto grass, straw, jute hemp, bagasse, milkweed floss fibers, and pineapple leaf fibers; and woody or pulp fibers such as those obtained from deciduous and coniferous trees, including softwood fibers, such as northern and southern softwood kraft fibers; hardwood fibers, such as eucalyptus, maple, birch, and aspen. Pulp fibers can be prepared in high-yield or low-yield forms and can be pulped in any known method, including kraft, sulfite, high-yield pulping methods and other known pulping methods. Fibers prepared from organosolv pulping methods can also be used.

The cellulosic fibers can generally be present in the dried web in an amount of from about 50% by weight or greater, such as in an amount of about 55% by weight or greater, such as in an amount of about 60% by weight or greater, such as in an amount of about 65% by weight or greater, such as in an amount of about 70% by weight or greater, such as in an amount of about 75% by weight or greater, such as in an amount of about 80% by weight or greater, such as in an amount of about 85% by weight or greater. The cellulosic fibers are generally present in the dried web in an amount of about 95% by weight or less, such as in an amount of about 85% by weight or less. As described above, the cellulosic fibers are typically shorter than the strength building fibers. The cellulosic fibers, for instance, can have an average fiber length of less than about 8 mm, such as less than about 6 mm, such as less than about 4 mm. The average fiber length of the cellulosic fibers is generally greater than about 1 mm, such as greater than about 2 mm, such as greater than about 3 mm.

The strength building fibers incorporated into the foam formed web of the present disclosure have relatively long fiber lengths. For example, the strength building fibers can have an average fiber length of greater than about 10 mm, such as greater than about 12 mm, such as greater than about 14 mm, such as greater than about 16 mm, such as greater than about 18 mm, such as greater than about 20 mm. The average fiber length of the strength building fibers is generally less than about 30 mm, such as less than about 25 mm, such as less than about 20 mm. The strength building fibers can be present in the dry web generally in an amount greater than about 5% by weight, such as in an amount greater than about 10% by weight, such as in an amount greater than about 15% by weight, such as in an amount greater than about 20% by weight, such as in an amount greater than about 25% by weight, such as in an amount greater than about 30% by weight, and generally in an amount less than about 50% by weight, such as in an amount less than about 40% by weight, such as in an amount less than about 35% by weight.

The strength building fibers can be any suitable fibers capable of increasing the strength of the web in at least one direction and/or increasing the abrasion resistance of the web. The strength building fiber, for instance, can comprise any suitable synthetic polymer fiber or any suitable regenerated cellulose fiber. Exemplary polymer fibers that may be incorporated in the web include, for instance, polyester fibers, polyolefin fibers such as polyethylene fibers and/or polypropylene fibers, and mixtures thereof. The polymer fibers can also be bicomponent fibers that include a sheath-core configuration or a side-by-side configuration.

Synthetic cellulose fiber types include rayon in all its varieties and other fibers derived from viscose or chemically-modified cellulose. Chemically treated natural cellulosic fibers can be used such as mercerized pulps, chemically stiffened or crosslinked fibers, or sulfonated fibers. For good mechanical properties in using papermaking fibers, it can be desirable that the fibers be relatively undamaged and largely unrefined or only lightly refined. While recycled fibers can be used, virgin fibers are generally useful for their mechanical properties and lack of contaminants. Mercerized fibers, regenerated cellulosic fibers, cellulose produced by microbes, rayon, and other cellulosic material or cellulosic derivatives can be used. In certain embodiments capable of high bulk and good compressive properties, the fibers can have a Canadian Standard Freeness of at least 200, more specifically at least 300, more specifically still at least 400, and most specifically at least 500.

In addition to the fiber furnish, the foam used to form the web can also contain various different components and chemicals. For instance, the fiber furnish used to form the base web can be treated with a chemical debonding agent. The debonding agent can be added to the foamed fiber slurry during the pulping process or can be added directly to the headbox. Suitable debonding agents that may be used in the present disclosure include cationic debonding agents such as fatty dialkyl quaternary amine salts, mono fatty alkyl tertiary amine salts, primary amine salts, imidazoline quaternary salts, silicone quaternary salt and unsaturated fatty alkyl amine salts. Other suitable debonding agents are disclosed in U.S. Pat. No. 5,529,665 to Kaun which is incorporated herein by reference. In particular, Kaun discloses the use of cationic silicone compositions as debonding agents.

In one embodiment, the debonding agent used in the process of the present disclosure is an organic quaternary ammonium chloride and, particularly, a silicone-based amine salt of a quaternary ammonium chloride. For example, the debonding agent can be PROSOFT® TQ1003, marketed by the Hercules Corporation. The debonding agent can be added to the fiber slurry in an amount of from about 1 kg per metric tonne to about 10 kg per metric tonne of fibers present within the slurry.

In an alternative embodiment, the debonding agent can be an imidazoline-based agent. The imidazoline-based debonding agent can be obtained, for instance, from the Witco Corporation. The imidazoline-based debonding agent can be added in an amount of between 2.0 to about 15 kg per metric tonne.

In one embodiment, the base web can be formed without using a debonding agent. Thus, the formed web can be free of any debonding agents.

Other optional chemical additives may also be added to the aqueous papermaking furnish or to the formed embryonic web to impart additional benefits to the product and process. The following materials are included as examples of additional chemicals that may be applied to the web. The chemicals are included as examples and are not intended to limit the scope of the invention. Such chemicals may be added at any point in the papermaking process.

Additional types of chemicals that may be added to the paper web include, but is not limited to, absorbency aids usually in the form of cationic, anionic, or non-ionic surfactants, humectants and plasticizers such as low molecular weight polyethylene glycols and polyhydroxy compounds such as glycerin and propylene glycol. Materials that supply skin health benefits such as mineral oil, aloe extract, vitamin E, silicone, lotions in general and the like may also be incorporated into the finished products.

In general, the products of the present disclosure can be used in conjunction with any known materials and chemicals that are not antagonistic to its intended use. Examples of such materials include but are not limited to odor control agents, such as odor absorbents, activated carbon fibers and particles, baby powder, baking soda, chelating agents, zeolites, perfumes or other odor-masking agents, cyclodextrin compounds, oxidizers, and the like. Superabsorbent particles may also be employed. Additional options include cationic dyes, optical brighteners, humectants, emollients, and the like.

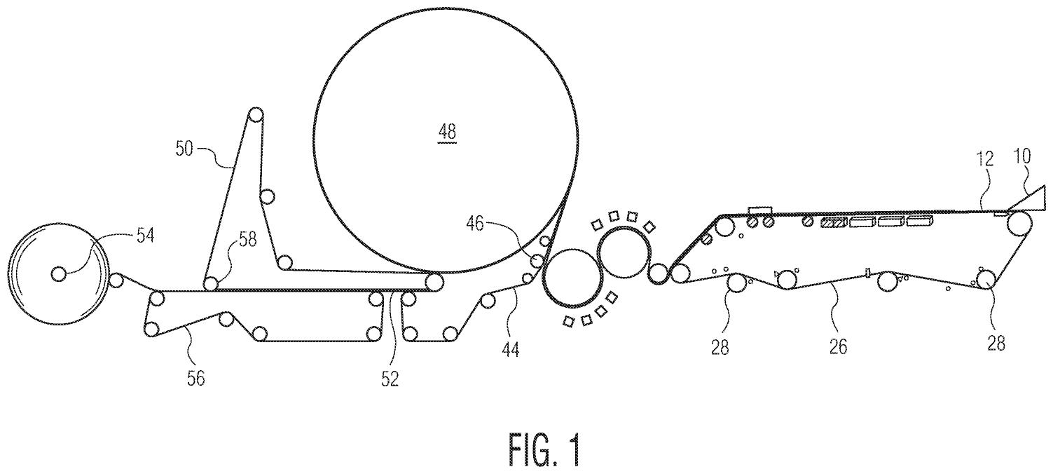

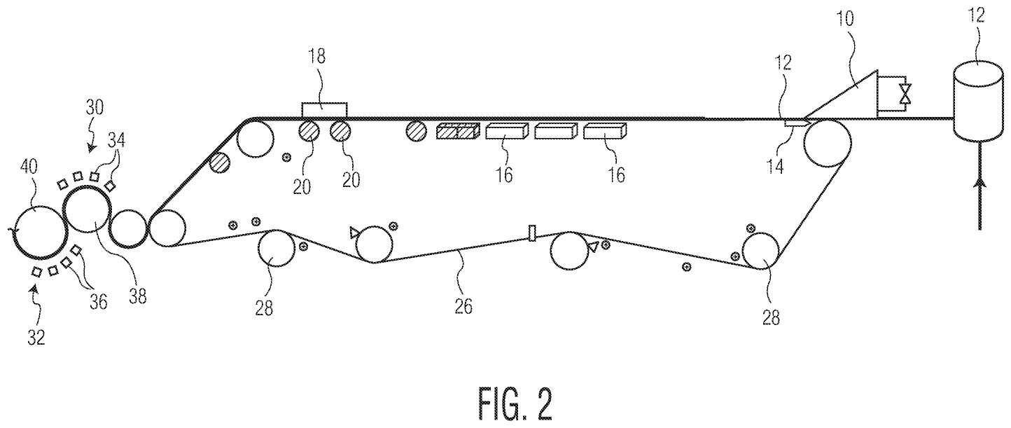

In order to form the base web, the foam is combined with a selected fiber furnish in conjunction with any auxiliary agents. The foamed suspension of fibers is then pumped to a tank and from the tank is fed to a headbox. FIGS. 1 and 2, for instance, show one embodiment of a process in accordance with the present disclosure for forming the web. As shown particularly in FIG. 2, the foamed fiber suspension can be fed to a tank 12 and then fed to the headbox 10. From the headbox 10, the foamed fiber suspension is issued onto an endless traveling forming fabric 26 supported and driven by rolls 28 in order to form a wet embryonic web 12. As shown in FIG. 2, a forming board 14 may be positioned below the web 12 adjacent to the headbox 10. Once formed on the forming fabric 26, the foam formed web can have a consistency of less than about 50%, such as less than about 20%, such as less than about 10%, such as less than about 5%. In fact, the forming consistency can be less than about 2, such as less than about 1.8, such as less than about 1.5. The forming consistency is generally greater than about 0.5, such as greater than about 0.8. The forming consistency indicates the ability to produce webs according to the present disclosure while minimizing the amount of water needed during formation.

Once the wet web is formed on the forming fabric 26, the web is conveyed downstream and dewatered. For instance, the process can optionally include a plurality of vacuum devices 16, such as vacuum boxes and vacuum rolls. The vacuum boxes assist in removing moisture from the newly formed web 12.

As shown in FIG. 2, the forming fabric 26 may also be placed in communication with a steambox 18 positioned above a pair of vacuum rolls 20. The steambox 18, for instance, can increase dryness and reduce cross-directional moisture variance. The applied steam from the steambox 18 heats the moisture in the wet web 12 causing the water in the web to drain more readily, especially in conjunction with the vacuum rolls 20. From the forming fabric 26, the newly formed web 12, in the embodiment shown in FIG. 1, is conveyed downstream, subjected to hydroentangling, and dried on a through-air dryer.

After the foam formed web has been produced, the web is subjected to one or more hydroentangling steps. In the embodiment illustrated in FIG. 2, for instance, the web 12 is subjected to two different hydroentangling steps. In particular, in FIG. 2, the web 12 is hydroentangled on a first surface during a first hydroentangling step and then hydroentangled on a second and opposite surface during a second hydroentangling step. As shown in FIG. 2, for example, the process can include a first hydroentangling device 30 and a second hydroentangling device 32. The hydroentangling that occurs at each hydroentangling station may be accomplished utilizing conventional hydroentangling equipment. The hydroentangling of the foam formed web may be carried out with any appropriate working fluid such as, for example, water. The working fluid flows through a manifold which evenly distributes the fluid through a series of individual holes or orifices. Exemplary holes or orifices, for example, can have a diameter of from about 0.003 inches to about 0.015 inches. For example, the manifold may include a strip of orifices having a diameter of 0.007 inches. The manifold may contain about 20 to about 40 holes per inch and can include 1 to 3 rows of holes. Many other manifold configurations and combinations may be used. In the embodiment illustrated in FIG. 2, for instance, the hydroentangling device 30 includes a plurality of injectors 34, while the hydroentangling device 32 includes a plurality of injectors 36. The injectors 34 and 36 can be part of the manifold and can be in communication with a working fluid supply.

During the hydroentangling process, the working fluid can pass through the orifices at pressures ranging from about 200 psig to about 3,500 psig. At the upper ranges of the described pressures, it is contemplative that the web may be processed at speeds of from about 500 ft/min to about 2000 ft/min. The fluid impacts the material or web which can be supported on a foraminous surface or wire or may be supported on a porous drum surface. In the embodiment illustrated in FIG. 2, for instance, hydroentangling occurs on a first drum 38 and a second drum 40. When supported on a foraminous surface or wire during hydroentangling, the wire can have a mesh size of from about 40×40 to about 100×100. The wire or surface may also be a multi-ply mesh having a mesh size of from about 50×50 to about 200×200.

As described above, alternatively, the web 12 can be placed directly onto the surface of the drum 38 and on the surface of the drum 40 during hydroentangling. Each drum can include a plurality of openings or vacuum passages for withdrawing excess water. These openings or vacuum passages can also create a pattern into the web 12 during the hydroentangling process. For example, a pattern can be formed into one surface of the web at the first hydroentangling station and a pattern can be formed into the second and opposite surface of the web at the second hydroentangling station. The use of a foam formed web has been found to create a unique and dramatic pattern as described above when hydroentangled due to the increased bulk of the foam formed web in comparison to conventional wetlaid webs. The pattern formed into each surface of the web 12 can be highly distinctive and can increase the aesthetic appeal of wiping products made from the web. In addition, the pattern formed into the web can be three dimensional including hills and valleys. This three dimensional topography can further improve the cleaning properties of wiping products made from the web.

In addition to improving the appearance of the web 12, the one or more hydroentangling stations can also significantly improve various physical properties of the web 12, such as the integrity of the web. For example, the columnar jets of working fluid which directly impact the surfaces of the web serve to entangle and intertwine the fibers contained in the web, especially the strength building fibers. The hydroentangling processes ultimately form a coherent entangled matrix. The hydroentangling steps also further serve to create a substantially homogeneous fiber mixture within the web. The resulting hydroentangled web, for instance, is “non-layered” and contains no distinguishable separate fibrous layers over the thickness of the web.

Once the foam formed web 12 is hydroentangled one or more times, the web can be dried using a non-compressive drying operation. For example, as shown in FIG. 1, the foam formed web can be dried using a through-air dryer.

Referring to FIG. 1, the foam formed and hydraulically entangled web 12 is transferred from the drum 40 to a throughdrying fabric 44 with the aid of a vacuum transfer roll 46 or a vacuum transfer shoe. If desired, the throughdrying fabric can be run at a slower speed than the web 12 to further enhance stretch. Transfer can be carried out with vacuum assistance to ensure deformation of the sheet to conform to the throughdrying fabric, thus yielding desired bulk and appearance if desired.

In the embodiment illustrated in FIG. 1, the foam formed web 12 is transferred to a throughdrying fabric 44. Alternatively, the foam formed web can be transferred to a metal, porous sleeve that forms the circumference of the throughdryer 48. The use of a metal sleeve instead of a fabric may provide various advantages. For instance, a porous metal sleeve may further create porosity for increasing the liquid absorbent properties of the web.

Alternatively, the foam formed web 12 can be conveyed on the throughdrying fabric 44 over the circumference of the throughdryer 48. The throughdrying fabric can contain high and long impression knuckles. For example, the throughdrying fabric can have about from about 5 to about 300 impression knuckles per square inch which are raised at least about 0.005 inches above the plane of the fabric. During drying, the web can be further macroscopically arranged to conform to the surface of the throughdrying fabric. Flat surfaces, however, can also be used in the present disclosure.

The side of the web contacting the throughdrying fabric is typically referred to as the “fabric side” of the base web. The fabric side of the base web, as described above, may have a shape that conforms to the surface of the throughdrying fabric after the fabric is dried in the throughdryer. The opposite side of the base web, on the other hand, is typically referred to as the “air side”. The air side of the web is typically smoother than the fabric side during normal throughdrying processes.

The level of vacuum used for the web transfers can be from about 3 to about 15 inches of mercury (75 to about 380 millimeters of mercury), preferably about 5 inches (125 millimeters) of mercury. The vacuum shoe or roll (negative pressure) can be supplemented or replaced by the use of positive pressure from the opposite side of the web to blow the web onto the next fabric in addition to or as a replacement for sucking it onto the next fabric with vacuum.

The web is finally dried to a consistency of about 94 percent or greater by the throughdryer 48 and thereafter transferred to a carrier fabric 50. The dried basesheet 52 is transported to the reel 54 using carrier fabric 50 and an optional carrier fabric 56. An optional pressurized turning roll 58 can be used to facilitate transfer of the web from carrier fabric 50 to fabric 56. Suitable carrier fabrics for this purpose are Albany International 84M or 94M and Asten 959 or 937, all of which are relatively smooth fabrics having a fine pattern. Although not shown, reel calendering or subsequent off-line calendering can be used to improve the smoothness and softness of the basesheet.

In one embodiment, the resulting foam formed web 52 is a textured web, which has been dried in a three-dimensional state. The texture in the web can be created due to the hydroentangling stations, due to the manner in which the web is dried using the through-dryer 48 or can be a result of both processes. For example, the web 52 can be dried while still including a pattern formed into the web.

In general, any process capable of forming a base web can also be utilized in the present disclosure. For example, a papermaking process of the present disclosure can utilize creping, double creping, embossing, air pressing, creped through-air drying, uncreped through-air drying, coform, hydroentangling, as well as other steps known in the art.

The basis weight of foam formed webs made in accordance with the present disclosure can vary depending upon the final product. For example, the process may be used to produce paper towels, industrial wipers, food service wipers, and the like. In general, the basis weight of the products may vary from about 15 gsm to about 120 gsm. The basis weight, for instance, can be greater than about 30 gsm, such as greater than about 40 gsm, such as greater than about 45 gsm, such as greater than about 50 gsm, such as greater than about 55 gsm, such as greater than about 60 gsm, such as greater than about 65 gsm, and generally less than about 100 gsm, such as less than about 90 gsm, such as less than about 80 gsm, such as less than about 75 gsm.

Of particular advantage, the process of the present disclosure can produce wiping products with increased strength at lower basis weights. For example, the foam forming process results in a more homogeneous fiber mixture throughout the web and improved formation. The one or more hydroentangling steps further serve to increase the homogeneous nature of the fiber mixture and increase web integrity and uniformity. Because the fibers are completely mixed within the web, the inherent properties of both the cellulosic fibers and the strength building fibers are present. With increased entanglement of the fiber matrix, strength is significantly increased. Increased strength allows the production of wiping products with lower basis weights than comparable wetlaid webs.

The process of the present disclosure can also produce webs and wiping products with good bulk characteristics. The bulk, for instance, can generally be greater than about 3 cc/g, such as greater than about 5 cc/g, such as greater than about 8 cc/g, such as greater than about 10 cc/g, such as greater than about 12 cc/g, and generally less than about 20 cc/g, such as less than about 15 cc/g.

The sheet “bulk” is calculated as the quotient of the caliper of a dry tissue sheet, expressed in microns, divided by the dry basis weight, expressed in grams per square meter. The resulting sheet bulk is expressed in cubic centimeters per gram. More specifically, the caliper is measured as the total thickness of a stack of ten representative sheets and dividing the total thickness of the stack by ten, where each sheet within the stack is placed with the same side up. Caliper is measured in accordance with TAPPI test method T411 om-89 “Thickness (caliper) of Paper, Paperboard, and Combined Board” with Note 3 for stacked sheets. The micrometer used for carrying out T411 om-89 is an Emveco 200-A Tissue Caliper Tester available from Emveco, Inc., Newberg, Oreg. The micrometer has a load of 2.00 kilo-Pascals (132 grams per square inch), a pressure foot area of 2500 square millimeters, a pressure foot diameter of 56.42 millimeters, a dwell time of 3 seconds and a lowering rate of 0.8 millimeters per second.

The foam formed web made according to the present disclosure can be used to produce a single ply product or a multiple ply product. In multiple ply products, the basis weight of each tissue web present in the product can vary. In general, the total basis weight of a multiple ply product will generally be the same as indicated above, such as from about 15 gsm to about 120 gsm. Thus, the basis weight of each ply can be from about 10 gsm to about 60 gsm, such as from about 20 gsm to about 40 gsm.

As described above, foam formed and hydroentangled webs made according to the present disclosure have a blend of physical properties that results in a wiping product having characteristics very similar to woven and/or knitted products. Foam formed webs made according to the present disclosure, for instance, can have excellent strength properties in both the machine direction and the cross-machine direction. For example, the machine direction to cross-machine direction tensile ratio of the webs can be from about 1:1 to about 4:1, such as from about 2 to about 3, such as from about 2.3 to about 2.7.

Of particular advantage, webs made according to the present disclosure can have comparable strength characteristics either when dry or when wet. For example, the wet strength of the web can be within about 20%, such as within about 10%, such as within about 5% of the dry strength of the web.

After the foam formed web is produced, the web can be processed in any suitable manner for use as a wiping product. For instance, in one embodiment, the web can be wound onto a core and shipped to consumers as a spirally wound product. Alternatively, the web can be cut into individual sheets, stacked and packaged. In still another embodiment, the web can be premoistened with a cleaning solvent. The cleaning solvent, for instance, may comprise any suitable solvent, such as an alcohol and water.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A wiping product comprising:
a foam formed web containing a mixture of fibers, the fibers comprising cellulosic fibers blended with strength building fibers, the strength building fibers having an average length of greater than about 8 mm and less than about 30 mm, the strength building fibers being present in the web in an amount from about 5% by weight to about 50% by weight and wherein the mixture of fibers have been hydroentangled.

2. The wiping product as defined in claim 1, wherein the strength building fibers comprise polyester fibers.

3. The wiping product as defined in claim 1, wherein the strength building fibers comprise polyolefin fibers.

4. The wiping product as defined in claim 1, wherein the strength building fibers comprise regenerated cellulose fibers, cotton fibers, or mixtures thereof

5. The wiping product as defined in claim 1, wherein the strength building fibers comprise bicomponent fibers.

6. The wiping product as defined in claim 1, wherein the strength building fibers are present in the web in an amount from about 10% to about 40% by weight.

7. The wiping product as defined in claim 1, wherein the cellulosic fibers comprise pulp fibers.

8. The wiping product as defined in claim 7, wherein the pulp fibers are present in the web in an amount from about 55% to about 80% by weight.

9. The wiping product as defined in claim 1, wherein the strength building fibers have an average fiber length of from about 10 mm to about 20 mm.

10. The wiping product as defined in claim 1, wherein the foam formed web has a first surface and a second and opposite surface and wherein the first surface has been subjected to hydroentangling and the second surface has been subjected to hydroentangling.

11. The wiping product as defined in claim 1, wherein the foam formed web is a single ply web and is non-layered.

12. The wiping product as defined in claim 1, wherein the foam formed web has a basis web of from about 15 gsm to about 120 gsm.

13. The wiping product as defined in claim 1, wherein the foam formed web contains a foaming agent.

14. The wiping product as defined in claim 13, wherein the foaming agent comprises lauryl sulfate.

15. The wiping product as defined in claim 13, wherein the foaming agent comprises sodium dodecyl sulfate, ammonium lauryl sulfate, a fatty acid amine, an amide, an amine oxide, or a fatty acid quaternary compound.

16. The wiping product as defined in claim 1, wherein the foam formed web has a bulk of from about 3 cc/g to about 15 cc/g.

17. The wiping product as defined in claim 1, wherein the foam formed web has a wet strength and has a dry strength and wherein the wet strength is within about 20% of the dry strength.

18. The wiping product as defined in claim 1, wherein the foam formed web has a wet strength and has a dry strength and wherein the wet strength is within about 10% of the dry strength.

19. The wiping product as defined in claim 1, wherein the wiping product comprises an industrial wiper.

20. The wiping product as defined in claim 19, wherein the industrial wiper includes a plurality of individual sheets stacked together.

21. The wiping product as defined in claim 1, wherein the wiping product is presaturated with a cleaning solvent.
